(19) United States
(12) Patent Application Publication
(10) Pub. No.: US 2005/0114725 A1
(43) Pub. Date: May 26, 2005

(54) Calibrating an integrated circuit to an electronic device

(75) Inventors: Jagrut V. Patel, San Diego, CA (US); Dexter Tamio Chun, San Diego, CA (US); Gregory Bullard, La Mesa, CA (US); Raghu Sankuratri, San Diego, CA (US); Rajeev Prabhakaran, San Diego, CA (US); Sanat Kapoor, San Diego, CA (US)

Correspondence Address: QUALCOMM Incorporated;Attn: Patent Department, 5775 Morehouse Drive, San Diego, CA, 92121-1714, US

(73) Assignee: Qualcomm, Inc.

(21) Appl. No.: 10/722,350

(22) Filed: Nov. 25, 2003

Related U.S. Application Data
(60) Provisional application No. 60/525,103, filed on Nov. 24, 2003.

(51) Int. Cl. G06F 1/04

(52) U.S. Cl. 713/500

(57) ABSTRACT

Systems and techniques are disclosed relating to calibrating an integrated circuit to an electronic component. The systems and techniques include an integrated circuit configured to generate a system clock and an external clock having a programmable delay from the system clock. The integrated circuit may also be configured to provide the external clock to the electronic component to support communications therewith, communicate with the electronic component, and calibrate the external clock delay as a function of the communications.

### CROSS REFERENCE TO RELATED APPLICATIONS

This application is related to and claims the benefit of the filing date of U.S. provisional application Ser. No. ______ (Attorney docket no. 50278-093), by Jagrut Patel, et. al., filed on Nov. 24, 2003, entitled “Calibrating an Integrated Circuit to an Electronic Device.”

### BACKGROUND

1. Field

The present disclosure relates to systems and techniques for calibrating an integrated circuit to an electronic device.

2. Background

Integrated circuits have revolutionized the electronics industry by enabling new applications which were not possible with discrete devices. Integration allows complex circuits consisting of millions of electronic components to be packaged into a single chip of semiconductor material. In addition, integration offers the advantages of fabricating hundreds of chips on a single silicon wafer, which greatly reduces the cost and increases the reliability of each of the finished circuits.

Integrated circuits are widely used today in electronic devices to implement sophisticated circuitry such as general purpose and specific application processors. A controller integrated onto the chip may be used to interface the various processors with off chip components, such as external memory and the like. Clocks generated by the controller may be used to access these off-chip components. These clocks should operate at a specific nominal speed, within a certain allowed tolerance, to ensure that the controller can communicate with the off-chip components under worst case temperature and voltage conditions.

Due to processes inherent in the silicon wafer fabrication process, a set of chips generated from a single wafer may fall into a range of different process speed ratings. Depending on the application, some manufacturers are forced to discard slow chips and fast chips that are outside of the nominal tolerance range. This leads to large amounts of waste, which can be very costly.

In an attempt to preserve those portions of the wafer that do not produce nominal chips, some manufacturers engage in a method of speed binning, in which the various chips produced from a single wafer are tested and batched according to their graded process speed. This method of batching chips according to their speed is time consuming and costly. Further cost is incurred as a result of selling slow chips and fast chips at reduced prices.

Accordingly, there is a need for a methodology wherein the operation of all chips from a single wafer may be guaranteed under worst case temperature and voltage conditions.

### SUMMARY

In one aspect of the invention, an electronic device includes an electronic component and an integrated circuit configured to generate a system clock and an external clock having a programmable delay from the system clock, the integrated circuit being further configured to provide the external clock to the electronic component to support communications therewith, communicate with the electronic component, and calibrate the external clock delay as a function of the communications.

In another aspect of the present invention, a method of calibrating an integrated circuit to an electronic component, the integrated circuit having a system clock. The method includes generating an external clock on the integrated circuit, the external clock having a programmable delay from the system clock, providing the external clock from the integrated circuit to the electronic component to support communications therewith, communicating between the integrated circuit and the electronic component, and calibrating the external clock delay as a function of the communications.

In yet another aspect of the present invention, an electronic device includes an electronic component, and an integrated circuit. The integrated circuit includes means for generating a system clock, means for generating an external clock having a programmable delay from the system clock, means for providing the external clock to the electronic component to support communications therewith, means for communicating between the integrated circuit and the electronic component, and means for calibrating the external clock delay as a function of the communications.

In a further aspect of the present invention, computer readable media embodying a program of instructions executable by a processor performs a method of calibrating an integrated circuit to an electronic component, the integrated circuit including a system clock and an external clock having a programmable delay from the system clock, the external clock being provided to the electronic component to support communications therewith. The method includes communicating between the integrated circuit and the electronic component, and calibrating the external clock delay as a function of the communications.

It is understood that other embodiments of the present invention will become readily apparent to those skilled in the art from the following detailed description, wherein various embodiments of the invention are shown and described by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Aspects of the present invention are illustrated by way of example, and not by way of limitation, in the accompanying drawings wherein:

FIG. 1 is a conceptual block diagram illustrating an example of an electronic device employing an integrated circuit;

FIG. 2 is a timing diagram illustrating an example of timing parameters to write to off-chip memory;

FIG. 3 is a timing diagram illustrating an example of timing parameters to read from off-chip memory;

FIG. 4 is a functional block diagram illustrating an example of the operation of a controller;

FIG. 5 is a flow chart illustrating an example of a calibration algorithm; and

FIG. 6 is a diagram with a number of bar charts to illustrate an example of how the calibration algorithm calibrates the various clocks generated by an integrated circuit.

### DETAILED DESCRIPTION

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details. In some instances, well-known structures and devices are shown in block diagram form in order to avoid obscuring the concepts of the present invention. Acronyms and other descriptive terminology may be used merely for convenience and clarity and are not intended to limit the scope of the invention.

In the following detailed description, various aspects of the present invention may be described in the context of an integrated circuit coupled to external memory. The integrated circuit may be an Application Specific Integrated Circuit (ASIC) with multiple processors. The external memory may be a Synchronous Dynamic Random Access Memory (SDRAM) or similar device. While these inventive aspects may be well suited for use with these components, those skilled in the art will readily appreciate that these inventive aspects are likewise applicable for use in various other electronic devices. Accordingly, any reference to a specific type of integrated circuit or off-chip component is intended only to illustrate the inventive aspects, with the understanding that such inventive aspects have a wide range of applications.

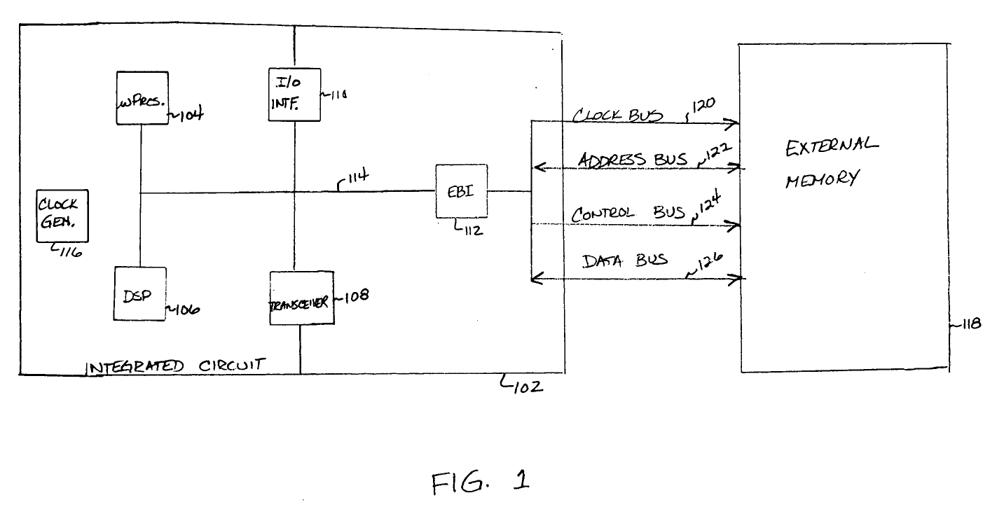

FIG. 1 is a conceptual block diagram of a electronic device employing an integrated circuit 102, such as an ASIC. The integrated circuit 102 may include a microprocessor 104, a Digital Signal Processor (DSP) 106, a transceiver 108, an input/output (I/O) interface 110, and an External Bus Interface (EBI) 112. All these components may be connected together with an Internal System Bus (ISB) 114. A clock generator 116 may be used to generate a system clock for system timing.

The microprocessor 104 may be used as a platform to run application programs that, among other things, provide user control and overall system management functions for the electronic device. The DSP 106 may be implemented with an embedded communications software layer which runs application specific algorithms to reduce the processing demands on the microprocessor 104. The transceiver 108 may be used to provide access to an external medium, such as a radio link in the case of a wireless telephone, terminal, Personal Data Assistant (PDA), or other similar device. In some embodiments, the transceiver 108 may provide access to Ethernet, cable modem line, fiber optics, Digital Subscriber Line (DSL), Public Switched Telephone Network (PSTN), or any other communications medium. In other embodiments, the electronics device may be self-contained without a transceiver to support external communications. The I/O interface 110 may be used to support various user interfaces. The user interfaces may include a keypad, mouse, touch screen, audio speaker, microphone, camera and/or the like.

The EBI 112 may be used to provide access between the components on the ISB 114. The EBI 112 may include a controller that provides an interface between the ISB 114 and one or more off-chip components, such as external memory 118. The interface may include a clock bus 120, an address bus 122, a control bus 124, and a data bus 126. Although not shown, the EBI may also provide an interface to a Liquid Crystal Display (LCD) and/or other user interface devices.

In at least one embodiment of a electronic device, the external memory may be a SDRAM. Alternatively, the external memory may be a Burst NOR, Burst PSRAM, RAM, ROM, EPROM, EEPROM, or any other memory device. In the case of a SDRAM, the controller may be used to generate an external clock and a feedback clock from the system clock. The external clock may be provided to the SDRAM over the clock bus 120 to read from and write to the SDRAM. The feedback clock may be used by the controller to sample data read from the SDRAM.

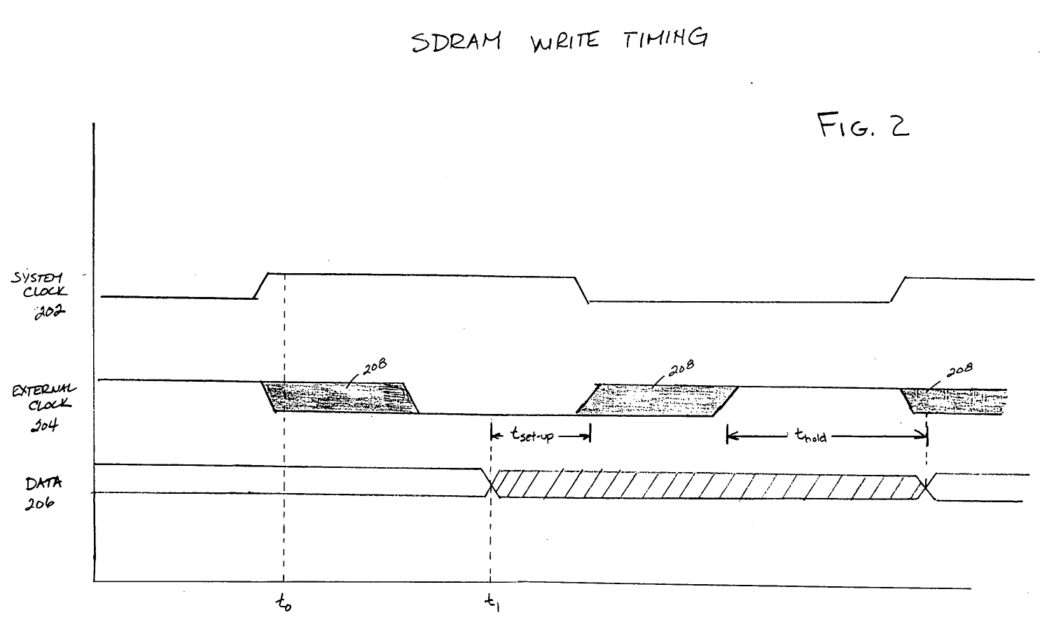

An example of the timing requirements to write to the SDRAM is shown in FIG. 2. The external clock 204 may be delayed from the system clock 202. Data 206 to be written to the SDRAM may be released onto the data bus 120 (see FIG. 1) from the controller shortly after the transition of the system clock at t₀. The short delay between the transition of the system clock and t₀ is due to the propagation delay of the controller. The data bus 120 (see FIG. 1) adds additional propagation delay, with the data arriving at the input to the SDRAM at t₁. The data at the input to the SDRAM is shown in FIG. 2 with cross-hatching. The data must then be stable at the input to the SDRAM for a brief period of time before the external clock transition to ensure reliable operation. This is called the “minimum set-up time,” and is denoted in FIG. 2 as tₛₑₜ₋ᵤₚ. There is also a period of time that the data must remain stable following the external clock transition. This is called the “minimum hold time,” and is denoted in FIG. 2 as t_{hold}. If the minimum set-up and hold times are not met, then the write operation to the SDRAM cannot be guaranteed. Thus, one can readily see from FIG. 2 that there is a minimum delay requirement between the system clock 202 and the external clock 204 to meet the minimum set-up time, and a maximum delay between the two to meet the minimum hold time. The delay may be programmable, and can be set anywhere between these boundaries, as shown in FIG. 2 by the shaded portion 208.

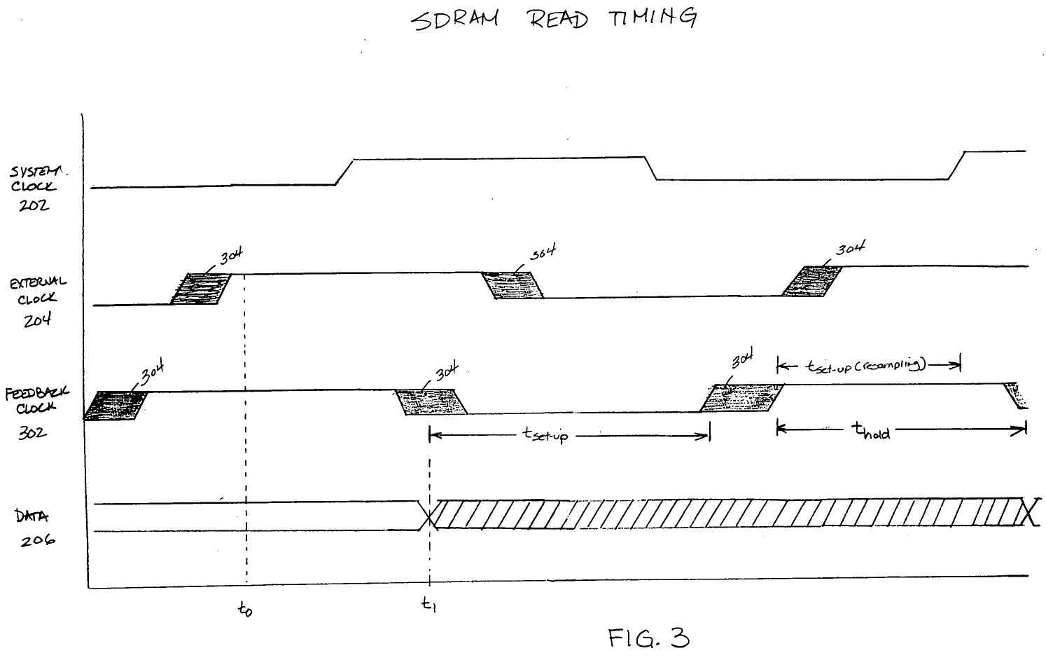

An example of the timing requirements to read from the SDRAM is shown in FIG. 3. As explained earlier in connection with FIG. 2, the external clock 204 may be delayed from the system clock 202. The feedback clock 302 may also be delayed from the system clock 202 as shown in FIG. 3. The feedback clock 302 may be used to read the data from the SDRAM into the controller. Data 206 may be released from the SDRAM onto the data bus 120 (see FIG. 1) shortly after the transition of the external clock at t₀. Due to the propagation delay of the SDRAM and the data bus 120 (see FIG. 1), the data arrives at the input to the controller at t₁. The data at the input to the controller (which is shown with cross-hatching) must remain stable for a brief period of time before the feedback clock transition. This period of time is defined by the minimum set-up time tₛₑₜ₋ᵤₚ of the controller. The data must also remain stable following the feedback clock transition for a period of time defined by the minimum hold time t_{hold} of the controller. Once the data is read into the controller with the transition of the feedback clock 302, it may be resampled by the system clock. The resampling process has its own requirements including a minimum set-up time in which the sampled data must remain stable before the next transition of the system clock. Thus, one can readily see from FIG. 3 that there is a minimum delay requirement between the system clock 202 and the feedback clock 302 to meet the minimum set-up time, and a maximum delay between the two to meet the minimum hold time and resampling set-up times. The delay may be programmable in the controller, and can be set anywhere between these boundaries, as shown in FIG. 3 by the shaded portion 304.

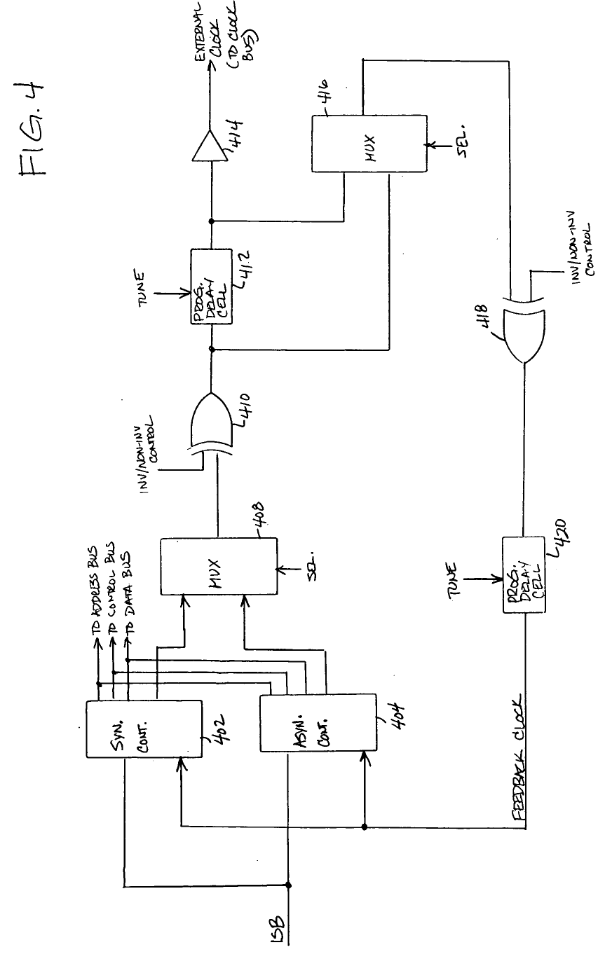

FIG. 4 is a functional block diagram of an embodiment of a controller. In the embodiment shown, the controller may be divided into a synchronous controller 402 and an asynchronous controller 404. This division is merely a design preference and those skilled in the art will readily understand that any configuration may be employed to perform the various functions described throughout this disclosure. The controllers 402 and 404 may be configured to interface the address bus 122, control bus 124, and data bus 126 to the ISB 114 by means well known in the art.

The controller may be used to generate the external and feedback clocks. A multiplexer 408 may be used to select the appropriate system clock depending on whether the data is clocked out of the synchronous or asynchronous controller. In the embodiment shown, the multiplexer 408 may be set to select the system clock used by the synchronous controller 402 to interface to the SDRAM. An exclusive OR gate 410 may be used to provide flexibility by providing an inverted or non-inverted system clock to the output. A programmable delay cell 412 may be used to set the delay of the external clock. The multiplexer and exclusive OR gate controls, as well as the delay of the external clock, may be programmed by software running on the microprocessor 104, or by any other means. A bus driver 414 may be used to provide the external clock to the SDRAM.

The feedback clock may be generated from either the system clock or the external clock. In the described embodiment, both clocks may be provided to a multiplexer 416 to provide some versatility to the software programmer. The selected system clock may be provided to an exclusive OR gate 418. The exclusive OR gate 418 allows either the inverted or non-inverted clock to be used. A programmable delay cell 420 may be used to delay the feedback clock. The feedback clock may then be fed back to the controllers 402 and 404. The multiplexer and exclusive OR gate controls, as well as the delay of the feedback clock, may be programmed by software running on the microprocessor 104, or by any other means.

As discussed earlier, certain timing constraints imposed by the controller and the SDRAM may limit the possible delay settings for the external and feedback clocks. The delay setting for the external clock, for example, may be constrained by the minimum set-up and hold times for the SDRAM. Similarly, the delay setting for the feedback clock may be constrained by the minimum set-up, hold and resampling set-up times for the controller. These timing constraints can vary with process, temperature and voltage.

The delay settings for the external and feedback clocks may be programmed during a characterization procedure at the factory. This process may entail the collection of characterization data for the integrated circuit across process, voltage and temperature. The delay settings may then be computed in a worst case analysis from the characterization data and the timing specifications for the SDRAM. These computed delay settings may used to calibrate the programmable delay cells on the controller. This approach may work quite well for one particular process corner, but may not work well for others.

Various methods may be implemented to make the system work across all possible process, voltage and temperature variations. By way of example, faster, and perhaps, more expensive memory devices may be used. Alternatively, stricter limitations may be imposed on the process spread and process shift during fabrication resulting in a higher yield of chips that may be used. Perhaps, a more attractive approach involves calibrating the delay settings on a per-device basis. A calibration algorithm embodied in software, or implemented in any other manner, may be enabled during factory test, every time the electronic device boots up, or continuously during its operation.

The calibration algorithm will be described in connection with FIGS. 2, 3 and 5. The calibration algorithm is constrained by five timing parameters. During the write operation, the clock delays should be programmed to satisfy the minimum set-up and hold times for the SDRAM (see FIG. 2). During the read operation, the clock delays should be programmed to satisfy the minimum set-up time, the hold time, and resampling set-up time for the controller (see FIG. 3). If any one of these five timing parameters cannot be met under worst case voltage and temperature conditions, then the data integrity of the controller cannot be guaranteed.

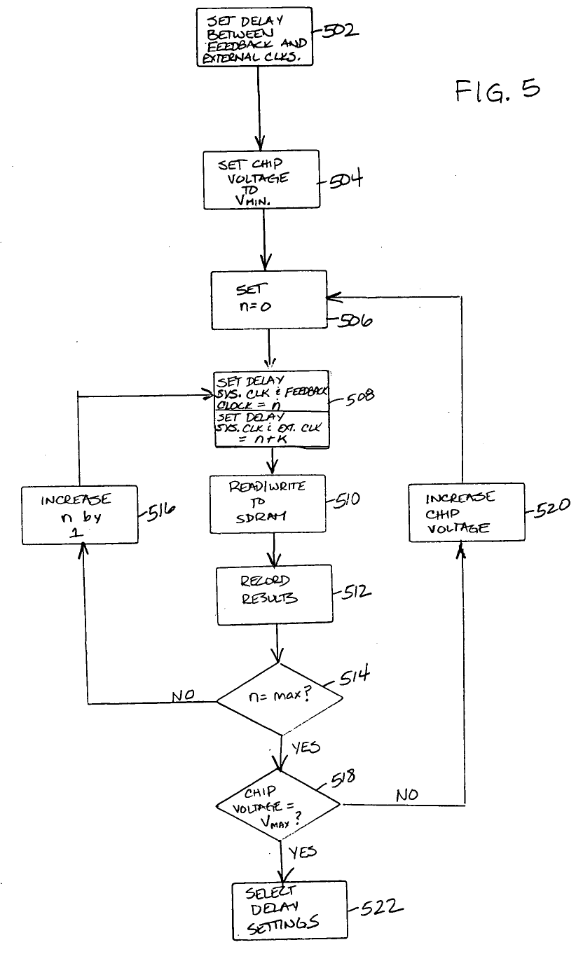

Returning to FIG. 3, one can readily see that the set-up time tₛₑₜ₋ᵤₚ for the controller is based on the delay from the transition of the external clock to the transition of the feedback clock. One can also see that the hold time t_{hold} is based on the delay from the transition of the feedback clock to the next transition of the external clock. Accordingly, If the delay between the external clock and the feedback clock is reduced, the set-up time tₛₑₜ₋ᵤₚ decreases and the hold time t_{hold} increases. Conversely, if the delay between the external clock and the feedback clock is increased, the set-up time tₛₑₜ₋ᵤₚ increases and the hold time t_{hold} decreases. Thus, the initial step of the calibration algorithm may be to compute the delay between the external clock and the feedback clock that satisfies both the minimum set-up and hold times of the controller under worst case propagation, voltage and temperature conditions. This is done in step 502 of FIG. 5.

Returning to FIG. 4, the computed delay between the external clock and the feedback clock may be implemented in a number of ways. By way of example, the feedback clock may be derived directly from the system clock by selecting the system clock with the multiplexer 416. The calibration algorithm may then be implemented by tuning the programmable delay cell 420 for the feedback clock through its full tuning range while accessing memory. At the same time, the programmable delay cell 412 for the external clock may be tuned through its full range with a constant offset (K). Since the feedback clock and external clock move together, the set-up time tₛₑₜ₋ᵤₚ and the hold time t_{hold} for the controller do not change, and therefore, cannot be a source of failure.

The only remaining timing parameter for the read operation is the minimum resampling set-up time tₛₑₜ₋ᵤₚ. Referring to FIG. 3, the resampling set-up time tₛₑₜ₋ᵤₚ is very long when the delay between the system clock and the feedback clock is small. However, as the delay between the two clocks is increased, the resampling set-up time tₛₑₜ₋ᵤₚ. likewise decreases until it reaches the minimum resampling set-up time tₛₑₜ₋ᵤₚ. This is the upper boundary of the calibration algorithm. If the delay between the system clock and the feedback clock is increased beyond the upper boundary, then the data integrity of the controller cannot be guaranteed.

Returning to FIG. 2, there are two more timing parameters that are of concern: the minimum set-up time tₛₑₜ₋ᵤₚ and the minimum hold time t_{hold} for the SDRAM. As a practical matter, however, the minimum hold time t_{hold} is normally not a limiting factor. This is because the hold time is approximately equal to the clock period less the set-up time tₛₑₜ₋ᵤₚ, which is much larger than the minimum hold time t_{hold}.

Once the delay between the feedback clock and the external clock is determined, the calibration algorithm may be used to sweep the tuning range of the programmable delay cells while accessing memory. More specifically, the calibration algorithm may begin with zero delay between the system clock and the feedback clock and incrementally increase the delay. For each incremental delay, the calibration algorithm causes the controller to read from and write to the SDRAM and then classifies each read and write attempt as a failure or success depending on the outcome.

In step 504, chip voltage may be set to the lowest rated voltage. In step 506, a variable n may be set to zero. The delay between the system clock and the feedback clock may then be set to n, and the delay between the system clock and the external clock may be set to n+K. This is done in step 508. The controller may then attempt to write to and read from the SDRAM, in step 510, and record the results in step 512. Next, in step 514, the calibration algorithm may then determine whether n equals the maximum delay between the system clock and the feedback clock. The maximum delay is one clock cycle. If n is less than the maximum delay, then n may be incremented by one in step 516. The calibration algorithm may then loop back to step 508 to perform another read/write operation and record the results. If, on the other hand, n equals the maximum delay between the system clock and the feedback clock, then the calibration algorithm may determine whether the chip voltage is at the highest rated voltage in step 518. If the chip voltage is less than the highest rated voltage, then the calibration algorithm may increment the chip voltage by some amount in step 520, and loop back to step 506 to sweep the full tuning range of the programmable delay cells again while accessing memory. If, on the other hand, the chip voltage is at the maximum rated voltage, then the delay settings may be selected in step 522. Although not shown, a temperature loop may also be added to ensure proper operation under worst case temperature conditions. However, in many applications, the speed of the chip does not vary much with temperature relative to variations due to process and voltage. In these applications, the effects of temperature can be ignored.

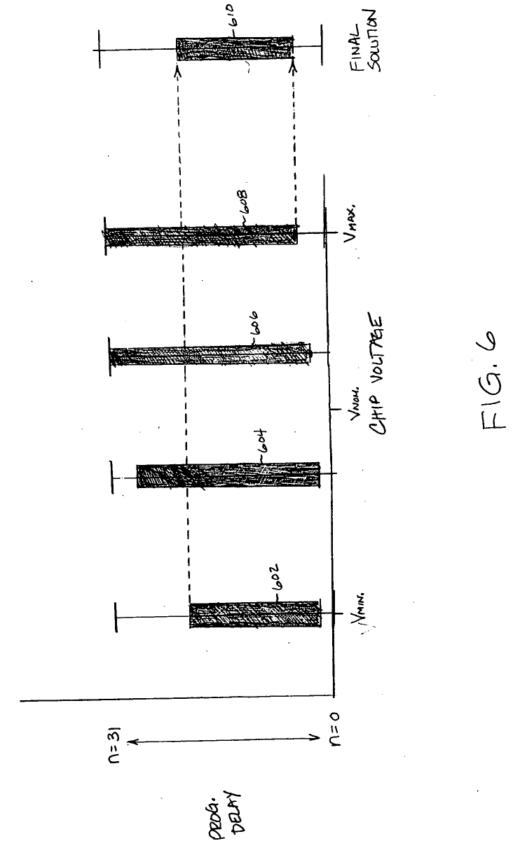

FIG. 6 shows the results of the read/write operation recorded in step 512 above. The results are shown in bar graph form with a bar graph for each chip voltage setting. The shaded areas of the bar graph indicate the n values in which the read/write operation was successful. The first bar graph 602 shows the results of the read/write operation at the minimum rated chip voltage. This bar graph has a lower boundary at n=2. This means that when n is less than 2, the minimum set-up time tₛₑₜ₋ᵤₚ for the SDRAM cannot be met, and therefore, the data integrity of the controller cannot be guaranteed. The bar graph also has an upper boundary at n=19. This means that when n is greater than 19, the minimum resampling set-up time tₛₑₜ₋ᵤₚ cannot be met, and therefore again, data integrity may be compromised. When n is between 2 and 19, inclusive, all five timing parameters are guaranteed at the minimum rated chip voltage.

The next bar graph 604 shows the results of the read/write operation at a chip voltage slightly below the nominal voltage. The lower boundary remains fixed at n=2, but the upper boundary has moved upward to n=28. This means that at a higher chip voltage, the minimum resampling set-up time tₛₑₜ₋ᵤₚ at the controller is reduced. This trend continues as the chip voltage increases. In the next two bar graphs 606 and 608, the upper boundary is equal to the maximum delay settings. The bar graph 606 shows the results of the read/write operation at a chip voltage slightly above nominal and the bar graph 608 shows the same at the maximum rated chip voltage. This means that at high chip voltages, the minimum resampling set-up time tₛₑₜ₋ᵤₚ at the controller can never be the cause of failure.

The bar graphs also show that lower boundary also increases with voltage. At a chip voltage slightly above nominal, the lower boundary has moved upward to n=3, and at the maximum rated chip voltage, the lower boundary is at n=5. This means that the programmable delay required to meet the minimum set-up time tₛₑₜ₋ᵤₚ at the SDRAM increases as the chip voltage increases.

The bar graph 610 shows the final solution. The lower boundary is fixed by the maximum lower boundary of the bar graphs 602, 604, 606 and 608. The upper boundary is fixed by the minimum upper boundary of the same bar graphs. In this case, the final solution has a lower boundary at n=5 and an upper boundary at n=19. Thus, when n is between 5 and 19, inclusive, all five timing parameters can be guaranteed under worst case voltage conditions. The calibration algorithm may set the programmable delay cells (see FIG. 4) accordingly. In at least one embodiment of the algorithm, the center value between the boundaries may be selected, such as n=12. This approach provides a good margin for both of the different types of failure mechanisms.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC. The ASIC may reside in the terminal, or elsewhere. In the alternative, the processor and the storage medium may reside as discrete components in the terminal, or elsewhere.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. An electronic device, comprising:
an electronic component; and
an integrated circuit configured to generate a system clock and an external clock having a programmable delay from the system clock, the integrated circuit being further configured to provide the external clock to the electronic component to support communications therewith, communicate with the electronic component, and calibrate the external clock delay as a function of the communications.

2. The electronic device of claim 1 wherein the communications comprise a plurality of transmissions from the integrated circuit to the electronic component, the integrated circuit being further configured to program a different external clock delay for each of the transmissions, and calibrate the external clock delay as a function of the transmissions.

3. The electronic device of claim 1 wherein the electronic component comprises memory.

4. The electronic device of claim 3 wherein the integrated circuit is further configured to generate a feedback clock having a programmable delay from the system clock, the integrated circuit being further configured to use the external clock to write to and read from the memory, and use the feedback clock to sample data read from the memory.

5. The electronic device of claim 4 wherein the integrated circuit is further configured to calibrate the feedback clock delay as a function of the communications.

6. The electronic device of claim 5 wherein the communications comprise a plurality of read/write operations, the integrated circuit being further configured to program a different external clock delay and a different feedback clock delay for each of the read/write operations, and calibrate the external clock delay and the feedback clock delay as a function of the read/write operations.

7. The electronic device of claim 6 wherein the integrated circuit is further configured to program the external clock delays and the feedback clock delays with a fixed offset between the external and feedback clocks for each of the read/write operations, and calibrate the external clock delay and the feedback clock delay with the fixed offset between the external and feedback clocks.

8. The electronic device of claim 7 wherein the integrated circuit is further configured calibrate the external clock delay and the feedback clock delay by determining the lowest delay between the system clock and one of the external and feedback clocks for a successful read/write operation and the highest delay between the system clock and said one of the external and feedback clock for a successful read/write operation, and selecting a delay therebetween, the selected delay being used to calibrate said one of the external and feedback clocks.

9. The electronic device of claim 8 wherein the selected delay comprises the center value between the lowest delay and the highest delay.

10. The electronic device of claim 3 wherein the memory comprises a Synchronous Dynamic Random Access Memory (SDRAM).

11. The electronic device of claim 1 wherein the electronic device comprises a wireless telephone.

12. A method of calibrating an integrated circuit to an electronic component, the integrated circuit having a system clock, comprising:
generating an external clock on the integrated circuit, the external clock having a programmable delay from the system clock;
providing the external clock from the integrated circuit to the electronic component to support communications therewith;
communicating between the integrated circuit and the electronic component; and
calibrating the external clock delay as a function of the communications.

13. The method of claim 12 wherein the communications comprise a plurality of transmissions from the integrated circuit to the electronic component, the method further comprising programming a different external clock delay for each of the transmissions, and wherein the calibration of the external clock delay is a function of the transmissions.

14. The method of claim 12 wherein the electronic component comprises memory.

15. The method of claim 14 further comprising generating a feedback clock on the integrated circuit, the feedback clock having a programmable delay from the system clock, and wherein the communications between the integrated circuit and the memory further comprise using the external clock to write to and read from the memory, and using the feedback clock to sample, at the integrated circuit, data read from the memory.

16. The method of claim 15 further comprising calibrating the feedback clock delay as a function of the communications.

17. The method of claim 16 wherein the communications between the integrated circuit and the memory comprise a plurality of read/write operations, the method further comprising programming a different external clock delay and a different feedback clock delay for each of the read/write operations, and wherein the calibration of the external clock delay and the feedback clock delay is a function of the read/write operations.

18. The method of claim 17 wherein the external clock delays and the feedback clock delays are programmed with a fixed offset therebetween for each of the read/write operations, and wherein the external clock delay and the feedback clock delay is calibrated with the fixed offset therebetween.

19. The method of claim 18 wherein the calibration of the external clock delay and the feedback clock delay further comprises determining the lowest delay between the system clock and one of the external and feedback clocks for a successful read/write operation and the highest delay between the system clock and said one of the external and feedback clock for a successful read/write operation, and selecting a delay therebetween, the selected delay being used to calibrate said one of the external and feedback clocks.

20. The method of claim 19 wherein the selected delay comprises the center value between the lowest delay and the highest delay.

21. The method of claim 14 wherein the memory comprises a Synchronous Dynamic Random Access Memory (SDRAM).

22. The method of claim 12 wherein the integrated circuit and the electronic component form at least part of a wireless telephone.

23. An electronic device, comprising:
an electronic component; and
an integrated circuit including,
means for generating a system clock,
means for generating an external clock having a programmable delay from the system clock,
means for providing the external clock to the electronic component to support communications therewith,
means for communicating between the integrated circuit and the electronic component, and
means for calibrating the external clock delay as a function of the communications.

24. The electronic device of claim 23 wherein the electronic component comprises memory, and wherein the integrated circuit further comprises means for generating a feedback clock on the integrated circuit, the feedback clock having a programmable delay from the system clock, wherein the means for communicating between the integrated circuit and the memory is performed by using the external clock to write to and read from the memory, and using the feedback clock to sample data read from the memory, and wherein the integrated circuit further comprises means for calibrating the feedback clock delay as a function of the communications.

25. Computer readable media embodying a program of instructions executable by a processor to perform a method of calibrating an integrated circuit to an electronic component, the integrated circuit including a system clock and an external clock having a programmable delay from the system clock, the external clock being provided to the electronic component to support communications therewith, the method comprising:
communicating between the integrated circuit and the electronic component; and
calibrating the external clock delay as a function of the communications.

26. The computer readable media of claim 25 wherein the electronic component comprises memory, and wherein the integrated circuit further includes a feedback clock having a programmable delay from the system clock, wherein the communication between the integrated circuit and the memory is performed by using the external clock to write to and read from the memory, and using the feedback clock to sample data, at the integrated circuit, read from the memory, and the method further comprises calibrating the feedback clock delay as a function of the communications.
